(19) United States
(12) Patent Application Publication
(10) Pub. No.: US 2005/0117716 A1
(43) Pub. Date: Jun. 2, 2005

(54) Communication system with a connectable resource channel

(76) Inventors: Robert A. Blaisch, Los Angeles, CA (US); Ninh Nguyen, Foothill Ranch, CA (US); Nabeel Khatri, Los Angeles, CA (US); Pat Burke, Wahoo, NE (US); Scott Bloom, Rocklin, CA (US); Trace Wax, San Francisco, CA (US); Michael Van Diest, Encino, CA (US); Henny Chen, South Pasadena, CA (US)

Correspondence Address: Eric K. Satermo;Registered Patent Agent, P.O. Box 19099, Irvine, CA, 92623-9099, US

(21) Appl. No.: 10/727,333

(22) Filed: Dec. 2, 2003

(51) Int. Cl. H04M 11/00

(52) U.S. Cl. 379/88.13; 379/88.18

(57) ABSTRACT

A communication system for interconnecting a plurality of communication devices includes a resource center and a softswitch. The resource center may include a computer such as an application server and a database of connection data. The softswitch may host a gateway that is remotely placed with respect to the resource center. The softswitch may be configured to connect a resource channel between one of the communication devices and the resource center and to connect an active channel between the same device and another one of the communication device. In addition, the softswitch may then disconnect the resource channel and reconnect the resource channel selectively upon actuation by a user. For example, a caller may actuation a resource-channel command on one of the communication. Upon receiving the command, the softswitch may cause the gateway to reconnect the resource channel. In some of the embodiments, the softswitch may store resource-channel data which may include data that enables the resource channel to be connected back to a desired level of the resource center. When the resource channel is connected, the resource center is configured to enable a user to initiate applications with voice commands.

### BACKGROUND OF THE INVENTION

The present invention relates to communication systems, particularly devices and methods for operating such systems.

Conventional communication systems provide connectivity between communication devices such as telephones. Resources of the systems have a finite bandwidth. Accordingly, when more users are on the system, more resources are being utilized, and less bandwidth results, and performance degrades.

Resource utilization and bandwidth have been particularly a focus of concern in recent history with the tremendous increase of users of cellular phones and Internet connectivity. Accordingly, system designers are concerned with developing systems that enhance the use of resources and bandwidth. In addition to system performance, designers are also concerned with enhancing the functionality of system to provide users with greater system versatility.

### BRIEF SUMMARY OF THE INVENTION

According to one aspect of the invention, a communication system for interconnecting a plurality of communication devices includes a resource center and a softswitch. The resource center may include a computer such as an application server and a database of connection data. The softswitch may host a gateway that is remotely placed with respect to the resource center. The softswitch may be configured to connect a resource channel between one of the communication devices and the resource center and to connect an active channel between the same device and another one of the communication device.

In a number of embodiments, the softswitch may then disconnect the resource channel and reconnect the resource channel selectively upon actuation by a user. For example, a caller may actuation a resource-channel command on one of the communication. Upon receiving the command, the softswitch may cause the gateway to reconnect the resource channel. In some of the embodiments, the softswitch may store resource-channel data which may include data that enables the resource channel to be connected back to a desired level of the resource center.

In addition, when the resource channel is connected, the resource center is configured to enable a user to initiate applications with voice commands. For example, a user may initiate an application which connects the user with another one of the communication devices. Alternatively, other applications may include functionality of pushing, sending, or playing content to any number of contacts.

Accordingly, the system of the invention enable a user to utilize resources that are located at a remote location without tying up overall system resources or bandwidth because the resource channel is disconnected when not needed. When a particular application is then desired, the resource channel can then be reconnected to enable the application to be initiated.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a block diagram illustrating a communication system according to a number of embodiments;

FIGS. 2A, 2B, and 2C illustrate the connectivity of an active channel and a resource channel between two communication devices according to some of the embodiments;

FIG. 3 illustrates a resource channel bridged into an active channel between communication devices;

FIG. 4 illustrates a resource channel connected to a communication device with an active channel disconnected;

FIG. 5 illustrates methodology for connecting a resource channel;

FIG. 6 illustrates functionality of an application server according to a number of embodiments;

FIG. 7 is a flow diagram illustrating an example of a CALL application;

FIG. 8 is a flow diagram illustrating an example of a SEND application;

FIG. 9 is a flow diagram illustrating an example of a FAX application;

FIG. 10 is a flow diagram illustrating an example of an INVITE application;

FIG. 11 is a block diagram of a telephony system according to other embodiments.

### DETAILED DESCRIPTION OF THE INVENTION

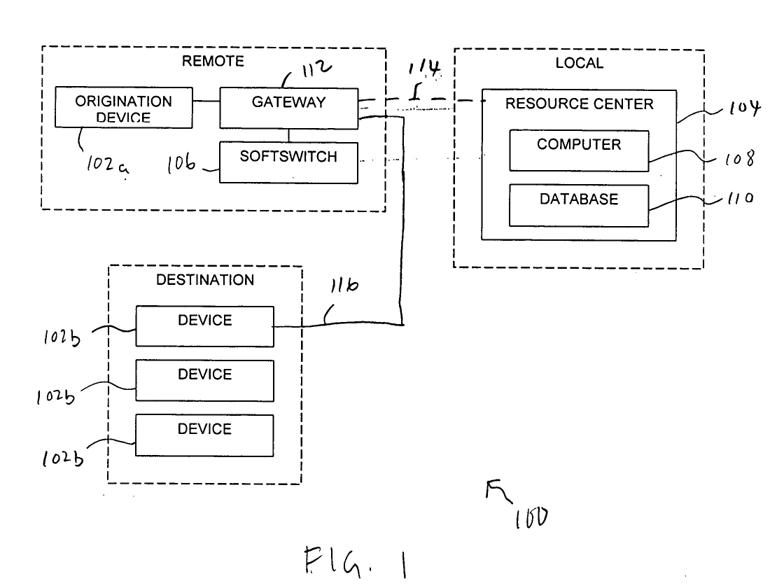

Referring to FIG. 1 of the drawings, a telephony system 100 interconnects a plurality of communication devices 102 such as telephones or computers. For the purposes of this description, one of the communication devices 102 is referred to as an origination device 102a that is utilized by a caller, and other communication devices 102 are referred to as destination devices 102b that are utilized by users.

In a number of embodiments, the system 100 may include a resource center 104 and a softswitch 106. The resource center 104 may include one or more computers 108 and one or more databases 110 for storing connection data. In some of the embodiments, the softswitch 106 may host a gateway 112. As illustrated in FIG. 1, the gateway 112 may be located remotely with respect to (i.e., physically separated from) the resource center 104. For example, the gateway 112 may be located in New York, while the resource center 104 may be located in Los Angeles. Accordingly, for the purposes of this description, the gateway 112 is indicated as REMOTE, and the resource center 104 is indicated as LOCAL in the drawings.

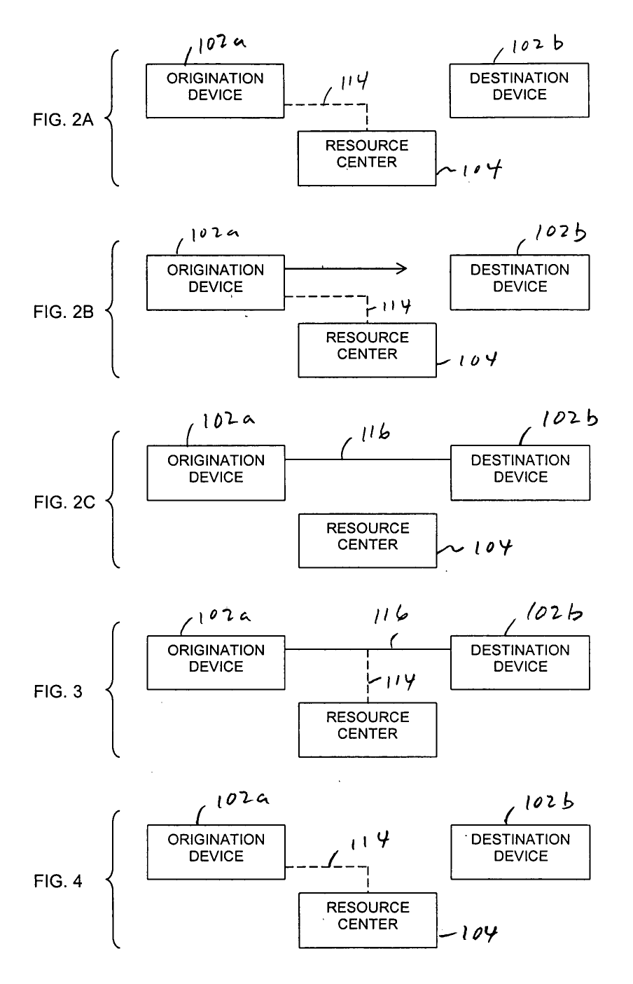

In some of the embodiments, the softswitch 106 may be a software application that is configured for hosting a gateway and facilitating connectivity between communication devices. More specifically, with additional reference to FIGS. 2A, 2B, and 2C, upon actuation by the caller via the origination device 102a, the softswitch 106 may connect the origination device 102a to the resource center 104 on a resource channel 114 as shown in FIG. 2A. Upon actuation again by the caller, the softswitch 106 may then initiate a connection between the origination device 102a with a destination device 102b on an active channel 116 as shown in FIG. 2B. If the destination device 102b responds and the active connection 116 is established, then the softswitch 106 may drop or disconnect the resource channel 114 from the origination device 102a as shown in FIG. 2C, thereby freeing up bandwidth in the system. Alternatively, the softswitch 106 may disconnect from the resource channel 114 upon initiating the active channel 116.

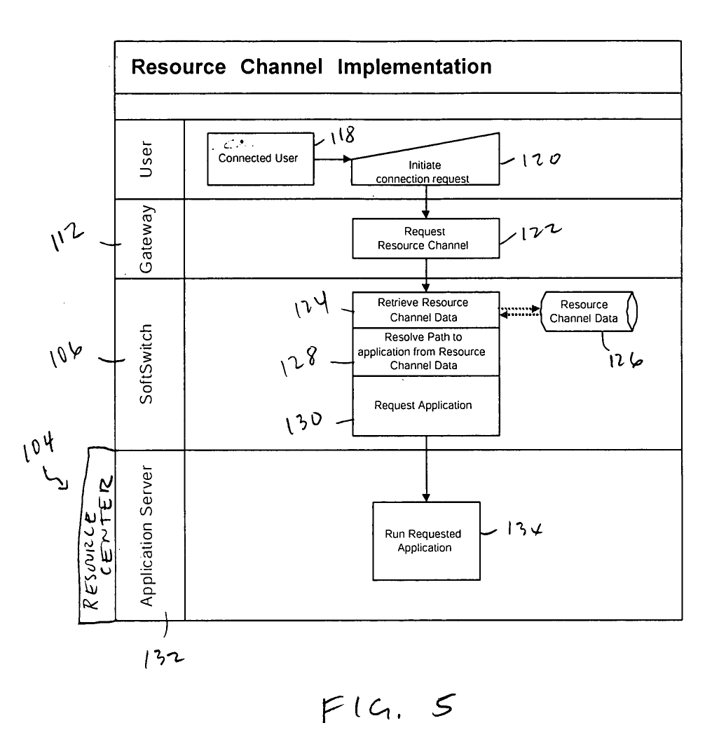

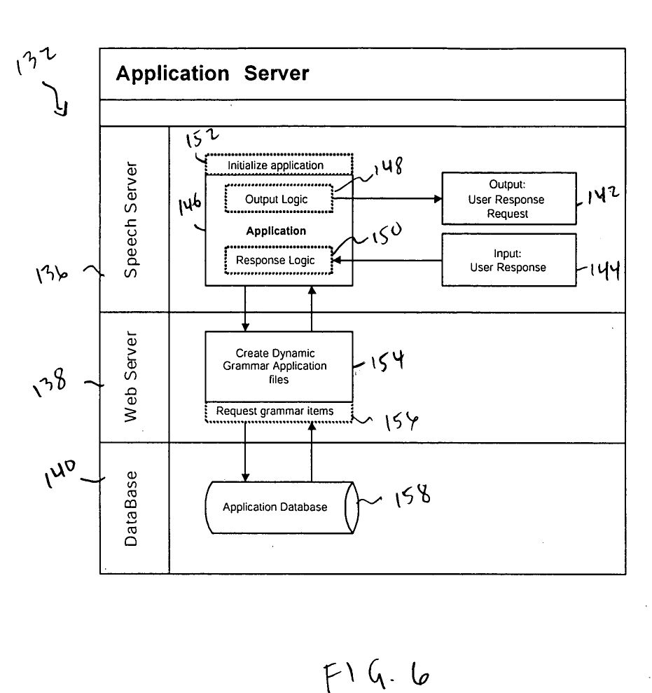

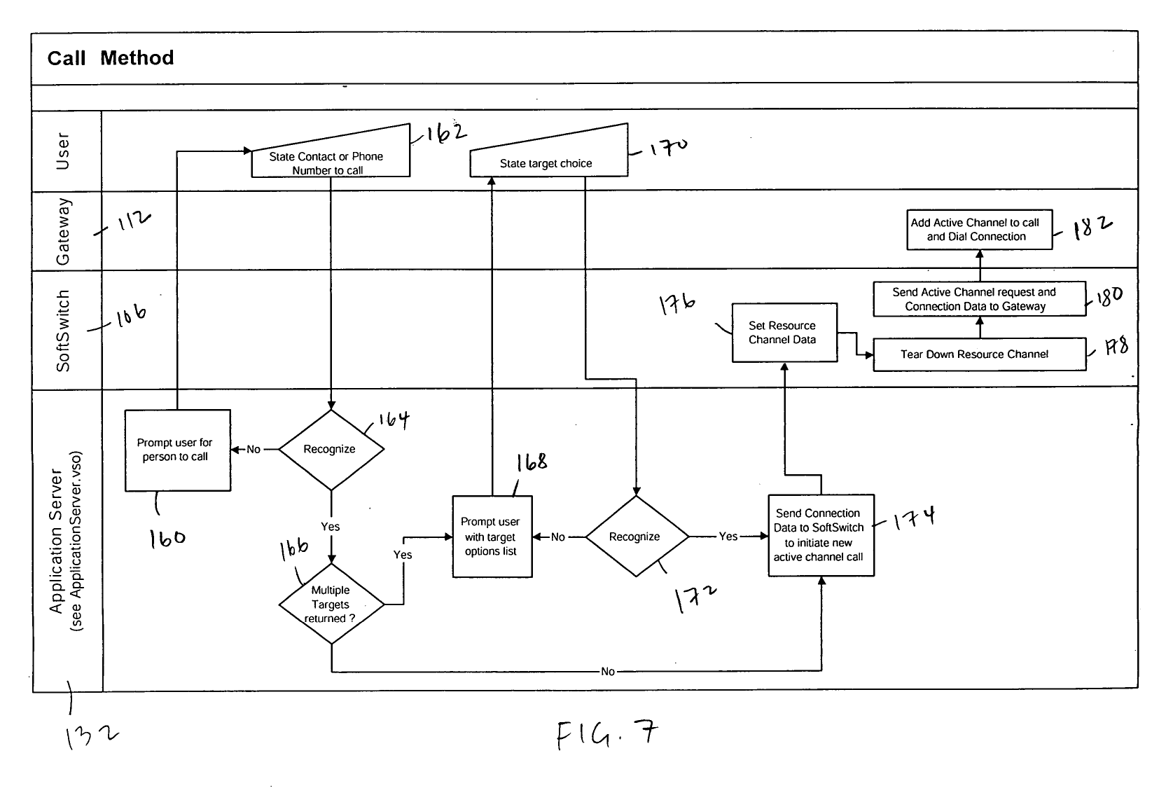

The caller may then cause the softswitch 106 to reconnect the resource channel 114 upon providing a resource-activation command on the origination device 102b. For example, the softswitch 106 may bridge the resource channel 114 into the active channel 116 as shown in FIG. 3. Alternatively, the softswitch 106 may drop or disconnect the active channel 116 between the devices 102 and reconnect the resource channel 114 with the origination device 102a as shown in FIG. 4. Accordingly, the resource channel 114 may connect the resource center 104 to and disconnect the resource center from the origination device 102a in response to a resource-activation command.

To describe the softswitch 106 and resource channel 114 in more detail, reference is made to FIG. 5. In a number of embodiments, a caller or connected user 118 may initiate 120 a connection request. If a resource channel 114 has not yet been connected, the connection request may be a telephone number associated with the resource center 104. In embodiments where the resource channel 114 has already been connected, the connection request may be made by dialing a resource-activation command on a standard keypad of a telephone, e.g., any combination of 1, 2, . . . , 9, 0, #, and *, such as ##, **, or 55. Upon receiving the resource-activation command, the gateway 112 may request 122 the resource channel 114. The softswitch 106 in turn may access or retrieve 124 resource-channel data from memory 126. The softswitch 106 may then utilize the resource-channel data to resolve 128 a path to an application and request 130 an application from the resource center 104. The resource center 104, which may include an application server 132, may then run 134 the requested application.

For the purposes of this description, the resource-channel data may include data indicative of the resource channel 114 that has been previously connected. The data may stored in session information and may include a softswitch ID, trunk and channel ID, customer account bill-to number, number or IP address to connect to, event ID, automatic number identification (ANI), flag for new or returning call, and last used application or grammar path statement.

If the caller desires the resource channel 114 to be bridged into the active channel 116 as shown in FIG. 3, then a predetermined resource-activation command specific to such a function may be actuated by a caller, such as ##. If the caller desired the resource channel 114 to be connected and the active channel 116 to be disconnected, then a predetermined resource-activation command specific to this function may be actuated by the caller, such as **. If it is desired drop the last call added to a conference call, then a predetermined resource-activation command specific to this drop function may be actuated by the caller, such as #0.

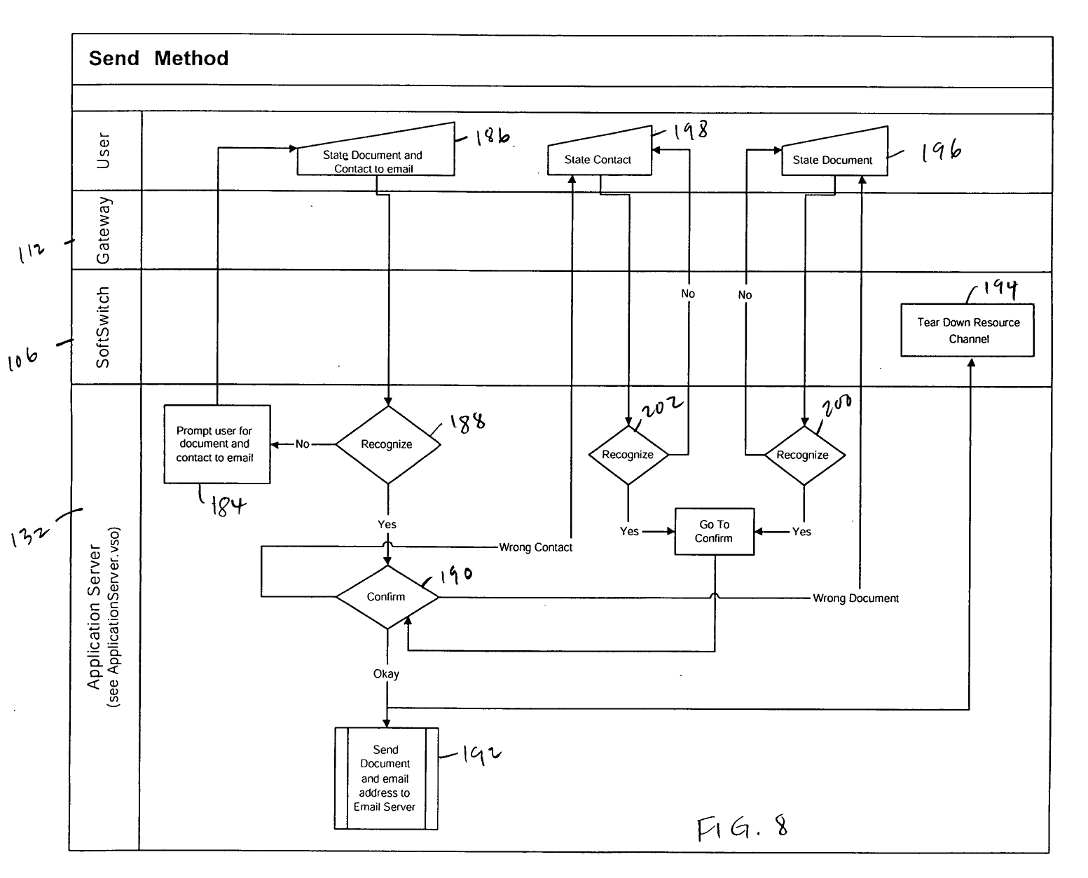

Reference is made to FIG. 6 with regard to a number of embodiments of the application server 132 of the resource center 104. The application server 132 may include one or more servers and databases, such as a speech server 136, a web server, and a database 140. The speech server 136 may be configured to interact with the caller by outputting 142 user response requests and receiving voice commands or user responses input 144 from the caller. Accordingly, in a number of embodiments the speech server 136 may include an application 146 with output logic 148 and response logic 150. Accordingly, the application 146 enables interaction with the caller by voice or speech when initialized 152. Depending upon the user response input 144, the web server 138 may be configured to create 154 dynamic grammar applications. The web server 138 may then request grammar items 156 from an application database 158 of the application-server database 140.

The grammar applications may include an extranet grammar and an intranet grammar. An extranet grammar may be configured to allow a user to define a set of voice commands that, when spoken on the resource channel 114, enable the user to achieve a desired result to interact with an application. An intranet grammar may be configured to allow a user to define a password-protected set of words that, when spoken on the resource channel 114, enable the user to initiate any number of applications. Examples of such application follow in more detail below.

As mentioned above, the application server 132 may be configured to run one of a plurality of applications based on input from the caller. For example, the caller may make a number of voice commands which the speech server 136 is configured to recognize. For example, the voice commands may include commands for causing the application server 132 to call one of the communication devices 102 (i.e., a contact associated with one of the devices), to send an object (e.g., a document, a photograph, an email, a facsimile, an invitation) either to one of the communication devices 102, or to perform another function. In addition, the plurality of applications may include sending a mail-merged document, fax, or email; pushing a URL, document, or file into an invitation web session; and playing a recorded program to interact with any number of users when the caller disconnects.

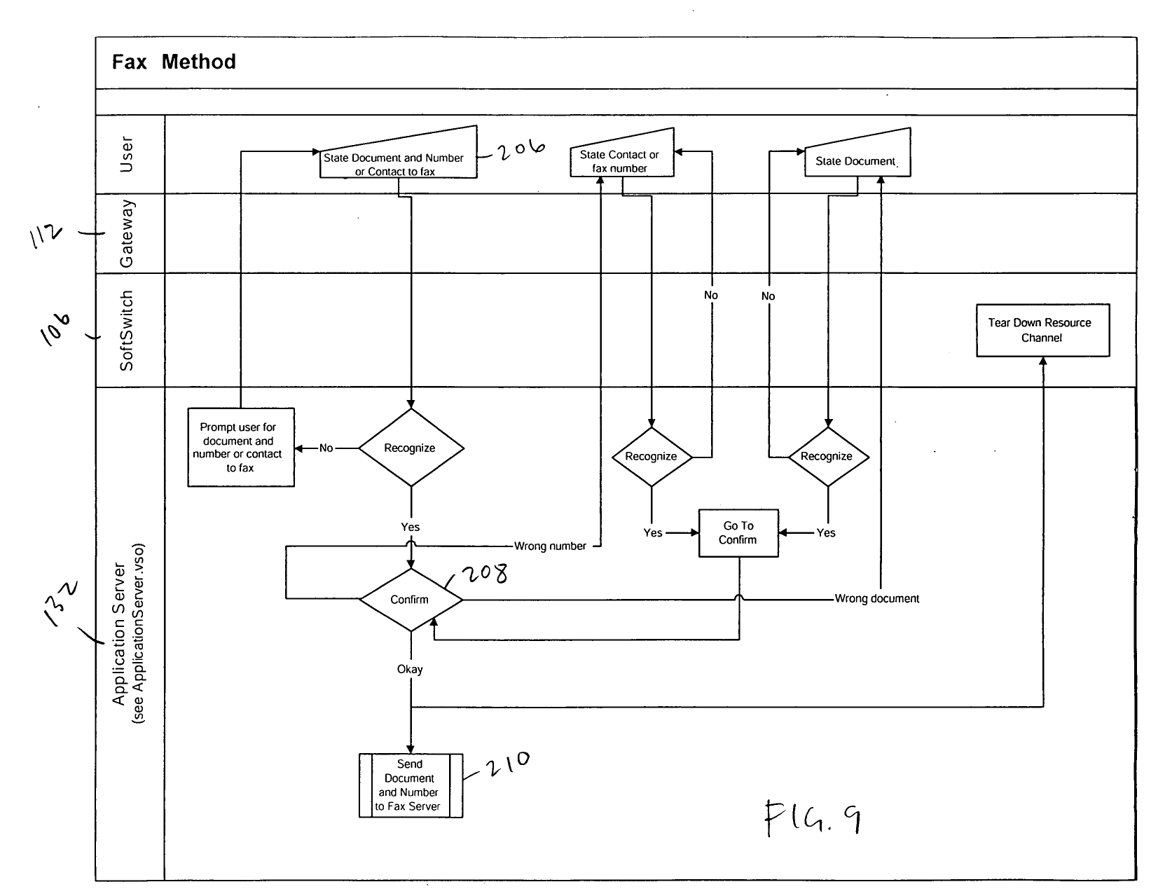

An example of methodology for implementing one of the voice commands, a CALL command, is illustrated in FIG. 7. In a number of embodiments, the caller may say “call” (or some other predetermined command) which is recognized by the speech server 136 (see FIG. 6), thereby causing a CALL application to be initialized. The speech server 136 may output 142 an audible prompt 160 to the caller such as “who” on the resource channel 114. The caller may then state 162 the name of a contact or a phone number to call. If the response from the caller is not recognized 164, then the application server 132 may prompt 160 the caller again. If the caller response is recognized 164, then the application server 132 may determine 166 whether or not there are multiple targets associated with the caller response. If there are, then the application server 132 may prompt 168 the caller with a list of the targets associated with the caller response. The caller may then state 170 the desired target, with the application server 132 utilizing another recognize 172 loop in response thereto.

Upon recognizing the desired target, the application server 132 may retrieve connection data associated with the desired target from the database 140 and then send 174 the connection data to the softswitch 106. The connection data may include telephone numbers, extensions, IP addresses, and so on. The softswitch 106 may set 176 the resource-channel data and then tear down or disconnect the 178 the resource channel 114. The softswitch 106 may then send 180 an active-channel request and the connection data to the gateway 112 which, in turn, may add or connect 182 the active channel 116 between the origination device 102a and one of the destination devices 102b.

An example of methodology for implementing another one of the voice commands, a SEND command, is illustrated in FIG. 8. In a number of embodiments, the caller may say “send” which is recognized by the speech server 136 (see FIG. 6), thereby causing a SEND application to be initialized. The speech server 136 may output 142 an audible prompt 184 to the caller such as “what” and “to whomp” on the resource channel 114. The caller may then state 186 the name of a document and the name of a contact to whom the document is to be sent. If the caller response is recognized 188, the application server 132 may then prompt the user to confirm 190 whether or not the document and the contact are correct by, for example, audibly responding to the caller. Upon receiving an affirmative response from the caller, the application server 132 may then send 192 the requested document, along with the email address of the requested contact, to an email server for execution. In addition, the application server 132 may then cause the softswitch 106 to disconnect or tear down 194 the resource channel 114. If the caller indicates the either the document or the contact are incorrect (at 190), then the application server may prompt the caller to state the name of the document 196 and/or the name of the contact 198. If recognized 202 and/or 204, then the application server 132 may then prompt the call to confirm 190.

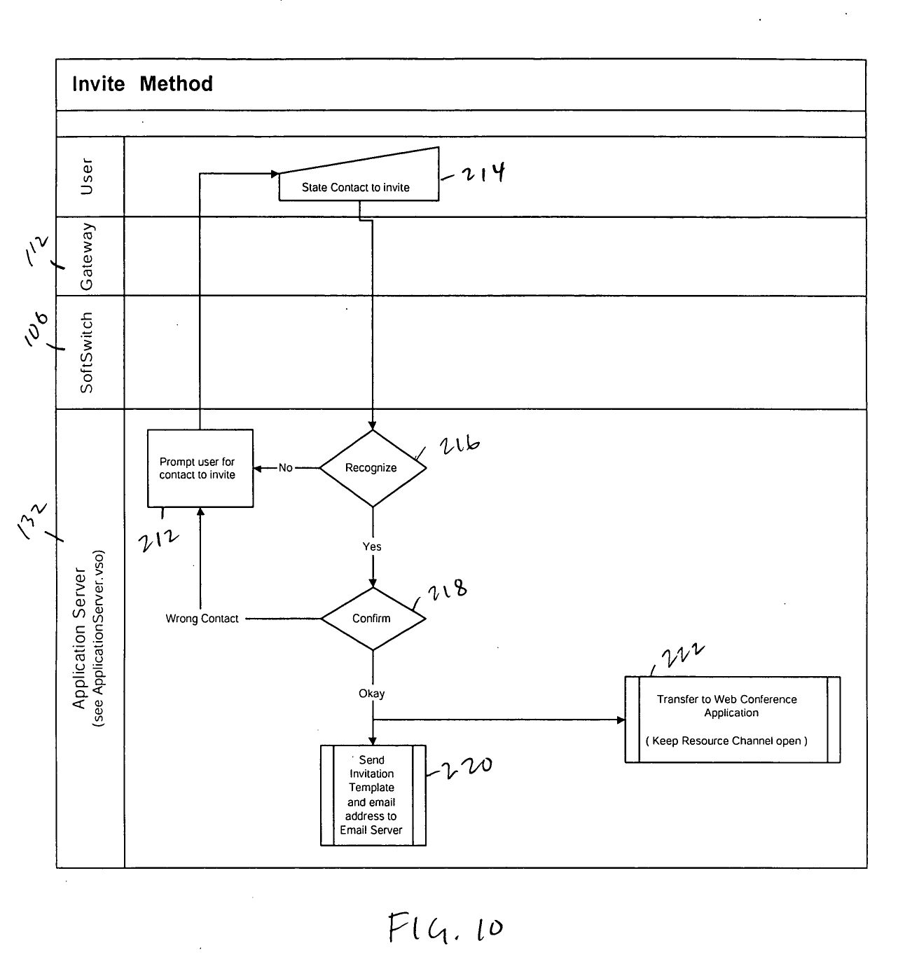

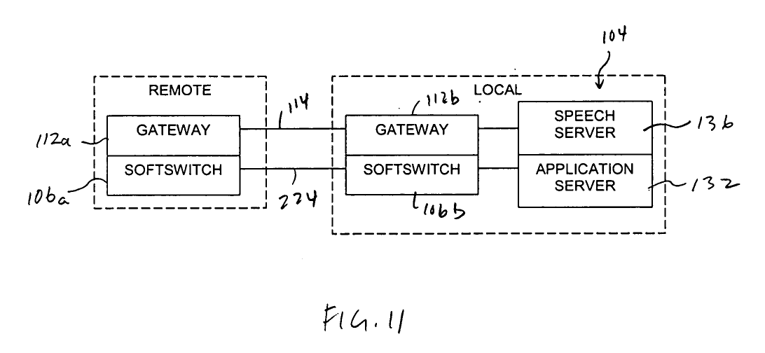

Yet another example of methodology for implementing another one of the voice commands, a FAX command, is illustrated in FIG. 9. The methodology for sending a fax is analogous to sending a document described above and will not be repeated herein. However, the caller may initiate the FAX application by saying “fax” rather than “send.” And rather than an email address, the application server 132 may prompt the call for a contact or a fax number 206. In addition, when an affirmative confirmation 208 is received, the application server 132 sends the requested document and associated fax number to a fax server 210.

Still another example of application methodology is illustrated in FIG. 9 in which the application server 132 is configured to implement an INVITE application. Upon initializing the application by saying “invite” or similar command, the application server 132 may prompt 212 the caller for a name of a contact in the database 140. The caller may then state 212 the name of the contact to invite. If recognized by the application server 132, the caller may then be prompted to confirm 218 whether or not the contact is correct. If so, then the application server 132 may send an invitation template and the email address associated with the contact to an email server. In addition, the application server 132 may transfer to a web conference application 222 while maintaining the resource channel 114 so that the caller may conference with one or more contacts.

With reference to FIG. 11, according to other embodiments the telephone system 100 may include a plurality of softswitches 106 and a plurality of gateways 112. For example, softswitch 106a and gateway 112a may be located remotely from softswitch 106b and gateway 112b, the latter of which may be associated with and located at the resource center 102. Accordingly, the resource channel 114 may be connected between the gateways 112, with the local gateway 112b in communication with the speech server 136. In addition, the softswitches 106 may communication with each other on a softswitch channel 224, with the local softswitch 106b in communication with the application server 132. The softswitch channel 224 may be an out-of-band signaling channel for transmitting connection data between the softswitches 106 or to the gateways 112.

For the purposes of this description, the gateway 112 may include a device for facilitating connectivity between communication devices. The gateway 112 may also perform conversion between circuit-switched data and packet-switched data. For example, the gateway 112 may include an External HW from EXCEL, SYSCO, or Hosted by Global Crossing.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

1. A telephony system for interconnecting a plurality of communication devices and a resource center, the system comprising:
an active channel for connecting at least two of the communication devices; and
a resource channel for connecting and disconnecting the resource center to at least one of the communication devices of the active channel in response to a resource-activation command from one of the communication devices.

2. The system of claim 1 wherein the communication devices of the active channel include an origination device;
the resource channel being connected between the origination device to the resource center prior to the active channel being connected between the origination device and another one of the communication devices.

3. The system of claim 2 further comprising memory for storing resource data indicative of the resource channel, wherein:
the resource memory data are accessed when the resource-activation command is provided.

4. A communication system for interconnecting a plurality of communication devices including an origination device utilized by a caller and a plurality of destination devices utilized by users, the system comprising:
a resource center including a computer and a database of connection data; and
a softswitch for hosting a gateway that is remotely placed with respect to the resource center, the softswitch for:
connecting a resource channel between the origination device and the resource center;
connecting an active channel between the origination device and a destination device;
disconnecting the resource channel; and
reconnecting the resource channel.

5. The system of claim 4 wherein the softswitch disconnects the active channel prior to reconnecting the resource channel.

6. The system of claim 4 wherein the softswitch maintains the active channel when reconnecting the resource channel.

7. The system of claim 4 further comprising a second softswitch for hosting a gateway associated with the resource center.

8. The system of claim 4 wherein the softswitch reconnects the resource channel based on resource-channel data indicative of the resource channel.

9. The system of claim 8 wherein the softswitch stores the resource-channel data.

10. The system of claim 4 wherein the softswitch reconnects the resource channel when the caller sends a resource activation command with the origination device.

11. The system of claim 10 wherein the origination device includes a keypad with a plurality of keys;
the resource activation command being generated by actuating at least one of the keys of the keypad.

12. The system of claim 4 wherein the resource center includes a speech server for interacting with the caller on the resource channel.

13. The system of claim 4 wherein the resource center includes an application server for enabling the user to cause one of a plurality of applications to be initiated.

14. The system of claim 13 wherein the plurality of applications includes an extranet grammar including a set of user-defined voice commands.

15. The system of claim 13 wherein the plurality of applications includes an intranet grammar including a set of password-protected voice commands.

16. The system of claim 15 wherein the set of voice command includes a CALL command for causing the resource center to initiate a telephone call on an active channel between the origination device and one of the destination devices.

17. The system of claim 15 wherein the set of voice command includes a SEND command for causing the resource center to send a digital item to one of the destination devices.

18. The system of claim 15 wherein the digital item includes a document.

19. The system of claim 15 wherein the digital item includes a fax.

20. The system of claim 15 wherein the digital item includes an e-mail.

21. The system of claim 15 wherein the digital item includes an invitation.

22. A softswitch for hosting a gateway in a communications system including a resource center and a plurality of communication devices, the resource center including an application server and a database, the communication devices including an origination device utilized by a caller and a plurality of destination devices utilized by users, the softswitch comprising a software application for:
connecting a resource channel between the origination device and the resource center;
connecting an active channel between the origination device and a destination device;
disconnecting the resource channel; and
reconnecting the resource channel upon a resource-activation command being received by the gateway from one of the communication devices.

23. A method for hosting a gateway in a communications system including a resource center and a plurality of communication devices, the resource center including an application server and a database, the communication devices including an origination device utilized by a caller and a plurality of destination devices utilized by users, the method comprising:
connecting a resource channel between the origination device and the resource center;
connecting an active channel between the origination device and a destination device;
disconnecting the resource channel; and
reconnecting the resource channel upon a resource-activation command being received by the gateway from one of the communication devices.
